(19) United States
(12) Patent Application Publication
(10) Pub. No.: US 2013/0177489 A1
(43) Pub. Date: Jul. 11, 2013

(54) CARBON DIOXIDE REMOVAL SYSTEM WITH A MEMBRANE SEPARATOR SYSTEM FOR AMMONIA RECOVERY

(71) Applicant: ALSTOM Technology Ltd, Baden (CH)

(72) Inventor: Sanjay K. Dube, Knoxville, TN (US)

(73) Assignee: ALSTOM Technology Ltd, Baden (CH)

(21) Appl. No.: 13/712,103

(22) Filed: Dec. 12, 2012

Related U.S. Application Data
(60) Provisional application No. 61/583,298, filed on Jan. 5, 2012.

(51) Int. Cl. B01D 53/62

(52) U.S. Cl. CPC B01D 53/62
USPC 423/220; 422/169; 422/170

(57) ABSTRACT

A CO₂ removal system includes an absorber for removing CO₂ from flue gas. The CO₂ removal system includes a regenerator in communication with the absorber. The regenerator separates CO₂ from the ionic solution and supplies regenerated ionic solution to the absorber. The CO₂ removal system includes a carbon dioxide water wash system in communication with the regenerator. The carbon dioxide water wash system receives a mixture of carbon dioxide and ammonia from the regenerator and separates the ammonia from the CO₂. The CO₂ removal system includes an ammonia water wash system in communication with the absorber and the carbon dioxide water wash system. The ammonia water wash system removes ammonia from the flue gas. The CO₂ removal system includes a membrane separator in communication with the ammonia water wash system, the regenerator and/or the carbon dioxide water wash system.

### CROSS-REFERENCE TO RELATED APPLICATION

This patent application claims priority benefit under 35 U.S.C. §119(e) of copending, U.S. Provisional Patent Application Ser. No. 61/583,298, filed Jan. 5, 2012, the disclosure of which is incorporated by reference herein in its entirety.

### FIELD

The present disclosure is generally directed to a chilled ammonia process (CAP) for carbon dioxide (CO₂) removal from flue gas and is more specifically directed to a CAP CO₂ removal system having a membrane separator system for recovering ammonia from an ionic solution.

### BACKGROUND

Energy used in the world can be derived from the combustion of carbon and hydrogen-containing fuels such as coal, oil, peat, waste and natural gas. In addition to carbon and hydrogen, these fuels contain oxygen, moisture and contaminants. The combustion of such fuels results in the production of a flue gas stream containing the contaminants in the form of ash, carbon dioxide (CO₂), sulfur compounds (often in the form of sulfur oxides, referred to as “SOx”), nitrogen compounds (often in the form of nitrogen oxides, referred to as “NOx”), chlorine, mercury, and other trace elements. Awareness regarding the damaging effects of the contaminants released during combustion triggers the enforcement of ever more stringent limits on emissions from power plants, refineries and other industrial processes. There is an increased pressure on operators of such plants to achieve near zero emission of contaminants. However, removal of contaminants from the flue gas stream requires a significant amount of energy.

### SUMMARY

According to aspects disclosed herein, there is provided a carbon dioxide removal system that includes an absorber that receives flue gas, for example, from a combustion system. The absorber contains an ionic solution in an interior area of the absorber. The ionic solution can remove carbon dioxide from the flue gas. The carbon dioxide removal system includes a regenerator that is in fluid communication with the absorber. The regenerator can separate carbon dioxide from the ionic solution and can supply regenerated ionic solution to the absorber. The carbon dioxide removal system includes a carbon dioxide water wash system in fluid communication with the regenerator. The carbon dioxide water wash system receives a mixture of carbon dioxide and ammonia from the regenerator and separates the ammonia from the carbon dioxide. The carbon dioxide removal system includes an ammonia water wash system that is in fluid communication with the absorber and the carbon dioxide water wash system. The ammonia water wash system can remove ammonia from the flue gas supplied thereto. The carbon dioxide removal system also includes a membrane separator in communication with the ammonia water wash system, the regenerator and/or the carbon dioxide water wash system.

When the membrane separator is in communication with the ammonia water wash system, the membrane separator separates water and/or molecular ammonia from ionic species in the ionic solution. The ionic solution can include ionic species such as, but not limited to NH4+, NH₂COO—, HCO3—, and CO₃²⁻.

In one embodiment, the membrane separator is an electrodialysis membrane system, a nano filtration system and/or a reverse osmosis system.

When the membrane separator is in communication with the carbon dioxide water wash system, the membrane separator supplies water to the carbon dioxide water wash system. The membrane separator can also supply the ionic species to the regenerator for further treatment.

In one embodiment, the carbon dioxide removal system includes an air stripper in communication with the membrane separator. The membrane separator can supply a mixture of water and molecular ammonia to the air stripper. The air stripper can also be in communication with the carbon dioxide water wash system and supply water thereto.

According to another aspect defined herein, a method for removing carbon dioxide from flue gas includes providing an absorber having an ionic solution contained therein. A regenerator is in fluid communication with the absorber and a carbon dioxide water wash system is in communication with the regenerator. An ammonia water wash system is in communication with the absorber and the carbon dioxide water wash system. A membrane separator in communication with the ammonia water wash system, the regenerator and/or the carbon dioxide water wash system, is also provided.

A flue gas containing carbon dioxide is received by the absorber and an ionic solution is supplied to the absorber. At least a portion of the carbon dioxide is removed from the flue gas and a carbon dioxide lean flue gas is generated by exposing the flue gas to the ionic solution. A portion of the ionic solution used to treat the flue gas is conveyed to the regenerator. The ionic solution is processed in the regenerator to separate a mixture of the carbon dioxide and ammonia from the ionic solution. The mixture of the carbon dioxide and the ammonia is conveyed to the carbon dioxide water wash system for removal of the carbon dioxide from the mixture. In particular, water is supplied to the carbon dioxide water wash system for separation of the carbon dioxide, during which a mixture of water and ammonia is created. The mixture of the water and the ammonia is conveyed to the ammonia water wash system. The carbon dioxide lean flue gas is also conveyed to the ammonia water wash system where the ammonia is recovered. As a result of the recovery of the ammonia, a mixture of ionic species and water is created in the ammonia water wash system. The mixture of the ionic species and the water are conveyed to the membrane separator for further processing. The membrane separator separates water and/or molecular ammonia from the ionic species in the ionic solution. The water can be conveyed to the carbon dioxide water wash system for use in separating the carbon dioxide from the mixture of carbon dioxide and ammonia.

Use of the membrane separator reduces the amount of energy required to operate the carbon dioxide removal system compared to prior art systems which use a steam consuming stripper column to separate the water and/or molecular ammonia from the ionic species in the ionic solution. For example, for coal fired power plants about a 20% reduction in energy requirements can be accomplished by using the membrane separator in lieu of the steam consuming stripper column. For natural gas fired power plants, about a 15% reduction in energy requirements can be accomplished by using the membrane separator in lieu of the steam consuming stripper column. For combined cycle power plants about a 40-50% reduction in energy requirements can be accomplished by using the membrane separator in lieu of the steam consuming stripper column.

### BRIEF DESCRIPTION OF FIGURES

With reference now to the figures where all like parts are numbered alike;

FIG. 1 is a schematic diagram of the CO₂ removal system disclosed herein;

FIG. 2 is schematic diagram of a membrane system of the CO₂ removal system of FIG. 1;

FIG. 3 is schematic diagram of another embodiment of the CO₂ removal system disclosed herein; and

FIG. 4 is schematic diagram of a membrane separator for use in the CO₂ removal system of FIGS. 1 and 2.

### DETAILED DESCRIPTION

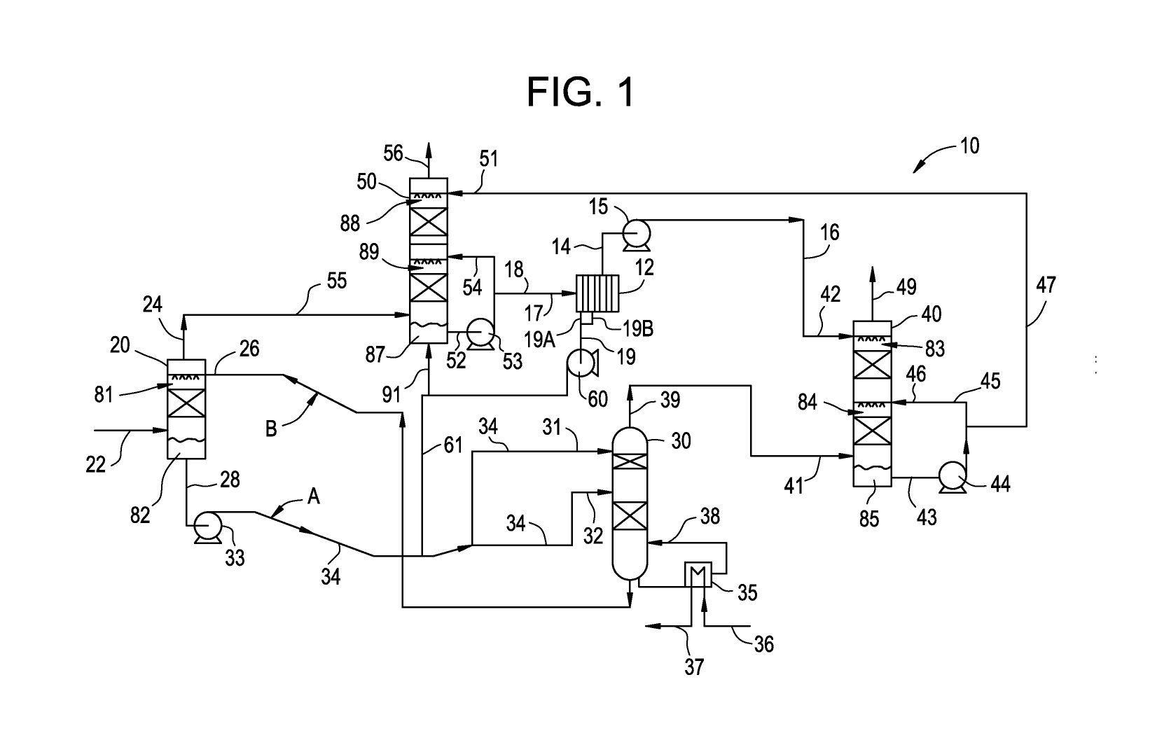

As illustrated in FIG. 1, a carbon dioxide (CO₂) removal system is generally designated by the numeral 10. The carbon dioxide removal system 10 includes a membrane separator system, such as but not limited to an electrodialysis membrane system 12 for separating water and ammonia from an ammonia containing ionic solution, as described below. The electrodialysis membrane system 12 is in fluid communication with an ammonia regenerator 30, a CO₂ water wash system 40 and/or a NH₃ water wash system 50, as described further below. The electrodialysis membrane system 12 is operable to separate water and/or molecular ammonia from ionic species of an ionic solution, as described below. While the membrane separator system is described as being an electrodialysis membrane system 12, the present disclosure is not limited in this regard as other types of membrane separator systems may be employed, including but not limited to a nano filtration system and/or a reverse osmosis system with or without the electrodialysis membrane system 12.

The carbon dioxide removal system 10 includes a CO₂ absorber 20, such as, but not limited to, a chilled ammonia CO₂ capture system. The CO₂ absorber 20 has a flue gas inlet 22 in communication with a flue gas exhaust of a combustion plant (not shown). The CO₂ absorber 20 includes a first outlet 24 for discharging CO₂ lean flue gas therefrom for further processing, as described below. The CO₂ absorber 20 further includes an inlet 26 for receiving an ionic solution for use in capturing the CO₂ from the flue gas. The ionic solution may be composed of, for example, water, ammonia (NH₃) and ammonium ions, such as ammonium cations NH₄+. The ammonia in the absorber 20 has a molarity of about 8 to 10 M. The CO₂ absorber 20 also includes an outlet 28 for discharging a CO₂ rich ionic solution therefrom. Although the ammonia in the absorber 20 is described as having a molarity of about 8 to 10 M, the present disclosure is not limited in this regard as the ammonia in the absorber 20 may have any molarity.

As illustrated in FIG. 1, the carbon dioxide removal system 10 includes the ammonia regenerator 30 for separating the CO₂ from a CO₂ containing ionic solution. The regenerator 30 is shown, for example, as having two inlets, namely a first inlet 31 and a second inlet 32 which are in fluid communication with the outlet 28 of the absorber 20. A first pump 33 is provided in a line 34 connecting the outlet 28 and the first and second inlets 31 and 32, respectively. The first pump 33 is configured to convey the ionic solution from the absorber 20 to the regenerator 30. A heat exchanger 35 having a steam supply 36 and condensate discharge 37 is provided for supplying heat to the regenerator 30 via a hot leg 38. The regenerator 30 includes an outlet 39 for discharging a mixture of CO₂ and NH₃ removed from the ionic solution. While the regenerator 30 is described as having two inlets 31 and 32, the present disclosure is not limited in this regard as the regenerator may have any number of inlets or stages without departing from the broader aspects disclosed herein.

As illustrated in FIG. 1, the carbon dioxide removal system 10 includes the CO₂ water wash system 40 for removing the NH₃ from the CO₂. The CO₂ water wash system 40 includes a first inlet 41 which is in fluid communication with the outlet 39 of the regenerator 30. The CO₂ water wash system 40 includes a second inlet 42 in fluid communication with a first outlet 14 of the electrodialysis membrane system 12. A second pump 15 is provided in a line 16 connecting the first outlet 14 and the second inlet 42, for conveying a fluid, such as, but not limited to water through the line 16. The CO₂ water wash system 40 includes an outlet 43 for discharging a fluid such as but not limited to a solution including ammonia and CO₂. A third pump 44 is provided in a recirculation line 45 which is in fluid communication with a third inlet 46 of the CO₂ water wash system 40. In addition, a branch line 47 is in fluid communication with the recirculation line 45. The water wash system 40 includes an outlet 49 on an upper portion thereof for discharging CO₂ therefrom. Although the CO₂ water wash system 40 is shown and described as having the second inlet 42 and the third inlet 46, the present disclosure is not limited in this regard as CO₂ water wash systems having any number of inlets or water wash stages may be employed.

As illustrated in FIG. 1, the carbon dioxide removal system 10 includes the NH₃ water wash system 50 for removing the NH₃ from the flue gas supplied thereto. The NH₃ water wash system 50 includes a water inlet 51 which is in fluid communication with the CO₂ water wash system 40 via the branch line 47, the third pump 44 and the outlet 43. The NH₃ water wash system 50 includes an outlet 52 for discharging an ionic solution therefrom. The outlet 52 is in fluid communication with a first inlet 17 of the electrodialysis membrane system 12, via line 18. A fourth pump 53 is provided to convey a fluid such as, but not limited to, the ionic solution through the line 18 and a recirculation line 54 which is in fluid communication with the NH₃ water wash system 50. The NH₃ water wash system 50 further includes a flue gas inlet 55 which is in fluid communication with the first outlet 24 of the absorber 20. The NH₃ water wash system 50 also includes another outlet 56 for discharging flue gas therefrom. Although the NH₃ water wash system 50 is shown and described as having the inlet 51 and flue gas inlet 55, the present disclosure is not limited in this regard as NH₃ water wash systems with any number of inlets and/or water wash stages may be employed. The NH₃ water wash system 50 contains ammonia having a molarity of about 1 to 1.5 M. In one embodiment, the NH₃ water wash system 50 contains ammonia having a molarity of about 0.5 to 3.0 M. Although, the NH₃ water wash system 50 is described as containing ammonia having a molarity of about 1 to 1.5 M or 0.5 to 3.0M, the present disclosure is not limited in this regard as the NH₃ water wash system 50 may contain ammonia of any molarity.

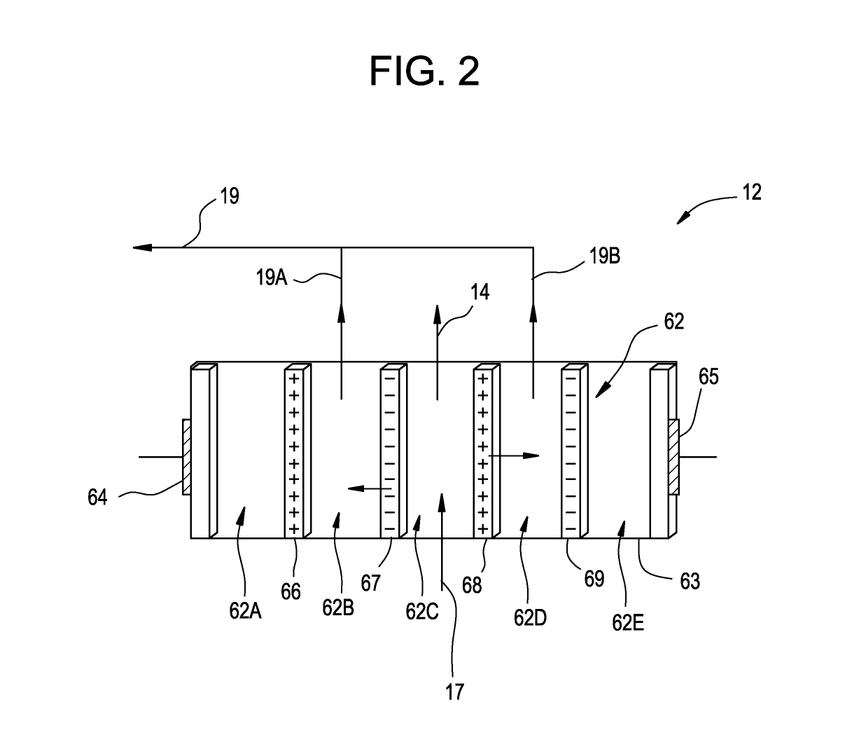

Referring to FIGS. 1 and 2, the electrodialysis membrane system 12 includes two outlets, namely a second outlet 19A and a third outlet 19B which merge into a common line 19. The common line 19 is in fluid communication with a fifth pump 60. The fifth pump 60 is in fluid communication with the regenerator 30 via a line 61, the line 34 and the first inlet 31. A branch line 91 extends from the line 61 and provides fluid communication with the NH₃ water wash system 50. The electrodialysis membrane system 12 has an interior area 62 defined by a housing 63.

An anode 64 is positioned on one side of the electrodialysis membrane system 12 and a cathode 65 is positioned on an opposing side thereof. The anode 64 and cathode 65 are coupled to a suitable electricity supply (not shown) for establishing an electrical potential between the anode and the cathode. The interior area 62 is segmented into five cavities 62A-E. A first cation exchange membrane 66 separates the cavity 62A and the cavity 62B. A first anion exchange membrane 67 separates the cavity 62B and the cavity 62C. A second cation exchange membrane 68 separates the cavity 62C and the cavity 62D. A second anion exchange membrane 69 separates the cavity 62D and the cavity 62E. The second outlet 19A is in fluid communication with the cavity 62B and the third outlet 19B is in fluid communication with the cavity 62D. The first inlet 17 and the first outlet 14 are in fluid communication with the cavity 62C. While the electrodialysis membrane system 12 is shown and described as having two anion exchange membranes 67 and 69 and two cation exchange membranes 66 and 68, the present disclosure is not limited in this regard as any number of anion and cation exchange membranes may be employed.

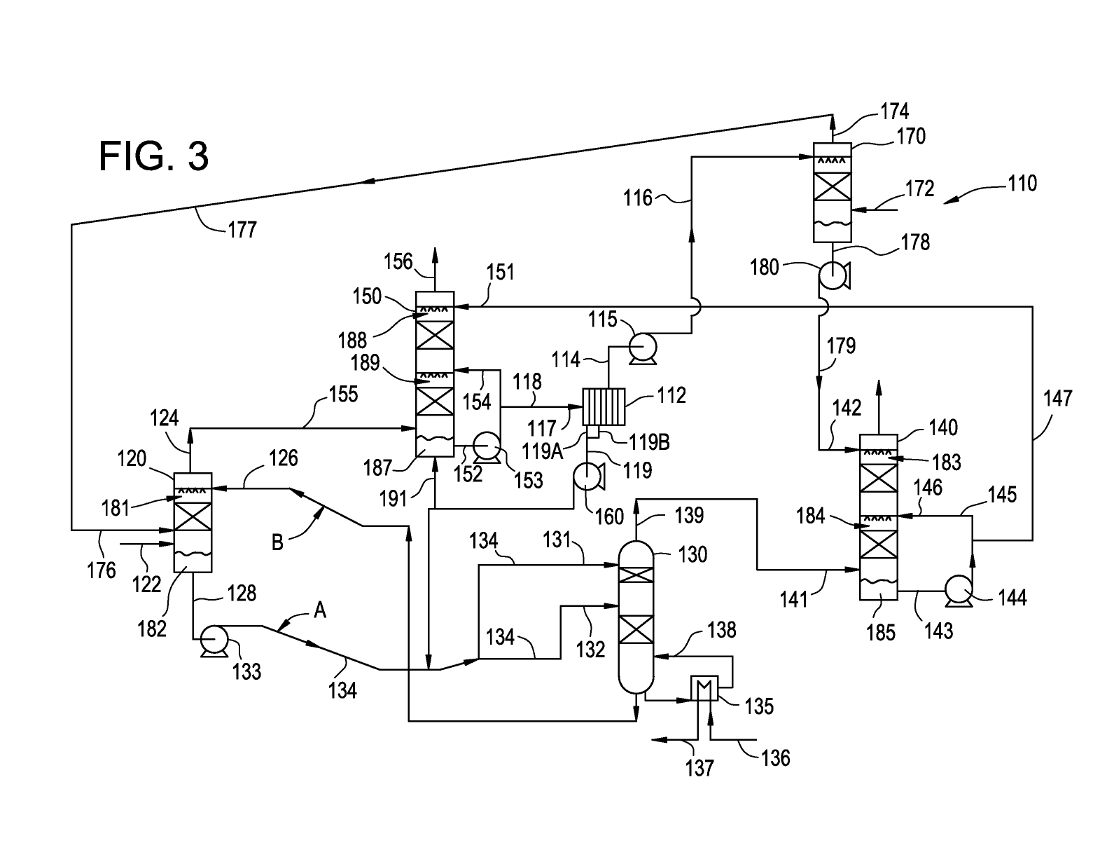

The carbon dioxide (CO₂) removal system illustrated in FIG. 3 is similar to that of FIG. 1. Thus like elements have been assigned like reference numbers preceded by the numeral 1. The CO₂ removal system 110 includes an electrodialysis membrane system 112 for separating water and ammonia from an ammonia containing ionic solution, as described below. The electrodialysis membrane system 112 is in fluid communication with an ammonia regenerator 130, an air stripping unit 170 and/or a NH₃ water wash system 150, as described further below.

Still referring to FIG. 3, the air stripping unit 170 includes an air inlet 172 for conveying air into the air stripping unit. The air stripping unit 170 includes a first outlet 174 that is in fluid communication with an inlet 176 of the absorber 120 via a line 177. The air stripping unit 170 includes a second outlet 178 that is in fluid communication with the second inlet 142 of the CO₂ water wash system 140, via line 179. A sixth pump 180 is provided in the line 179 to convey fluids from the air stripping unit 170 to the CO₂ water wash system 140.

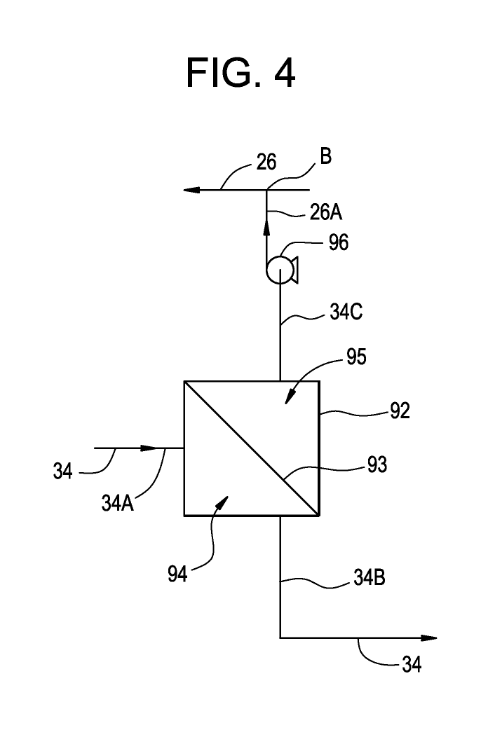

Referring to FIG. 4, a membrane separator 92 includes a membrane 93 defining a retentate side 94 and a permeate side 95 located on opposing sides of the membrane. The membrane separator 92 includes a second inlet 34A, a first outlet 34 B and second outlet 34C. The first inlet 34A and the second outlet 34B are in communication with the retentate side 94. The second outlet 34C is in fluid communication with the permeate side 95. The membrane separator 92 is operable to generate a permeate flow of about 90% of an amount of fluid entering the membrane separator and a retentate flow of about 10% of the amount of fluid entering the separator. The membrane separator 92 is operable to treat a feed solution that includes about 0.52 molar % CO₂; 1.3 molar % NH₃; 80.6 molar % H₂O; 9.4 molar % NH⁴⁺; 4.4 molar % NH₂COO⁻; 3.7 molar % HCO³⁻; and 0.6 molar % CO₃²⁻ by producing a retentate including NH₂COO⁻; HCO³⁻; and CO₃²⁻ and a permeate including NH₃; H₂O; and NH⁴⁺. The separator is configured to be installed in an in-series configuration at point A in the line 34 of either or both of the CO₂ removal systems 10 (FIG. 1) and/or 110 (FIG. 3), such that the first inlet 34A is in fluid communication with the first pump 33, 133 and the first outlet 34B is in fluid communication with the first inlet 31 (131) and the second inlet 32, 132 of the regenerator 30, 130. In addition, the second outlet 34C of the separator 92 is in fluid communication with a seventh pump 96. The seventh pump 96 is in fluid communication with the line 26, 126 via a line 26A via a branch connection at point B. The second outlet is in communication with the CO₂ water wash system 40, 140 via the absorber 20, 120 and the NH3 water wash system 50, 150.

While the feed solution is described as including about 0.52 molar % CO₂; 1.3 molar % NH₃; 80.6 molar % H₂O; 9.4 molar % NH⁴⁺; 4.4 molar % NH₂COO⁻; 3.7 molar % HCO³⁻; and 0.6 molar % CO₃²⁻, the present disclosure is not limited in this regard as other concentrations, compounds and ionic species may be employed without departing from the broader aspects disclosed herein. Although the membrane separator 92 is described as being operable to generate a permeate flow of about 90% of an amount of fluid entering the membrane separator and a retentate flow of about 10% of the amount of fluid entering the separator and producing a retentate including NH₂COO⁻; HCO³⁻; and CO₃²⁻ and a permeate including NH₃; H₂O; and NH⁴⁺, the present disclosure is not limited in this regard as other membranes which produce other percentages of retenate and permeate and/or other compositions of permeate and/or retentate may be employed without departing from the broader aspects disclosed herein.

The presence of molecular and ionic ammonia in solutions used in ammonia based CO₂ removal systems is dependent on the pH and the temperature of the solution. For example, if the pH of the solution exiting the CO₂ water wash system 40 via line 47 is low, for example, having a pH of about 6 to 9 or 4 to 9, then molecular ammonia will be present at an amount of about 0 to 10% of the total ammonia content. However, if the pH of the solution is high, for example, having a pH of about 9 to 12, then molecular ammonia will be present at an amount of about 10 to 100% of the total ammonia content. The CO₂ removal system 10 of FIG. 1 is used when the pH of a solution flowing through the electrodialysis membrane system 12 is in the range of about 6 to 9. In one embodiment, the CO₂ removal system 10 of FIG. 10 is used when the pH of a solution flowing through the electrodialysis membrane system 12 is in the range of about 4 to 9. The CO₂ removal system 110 of FIG. 3 is used when the pH of the solution flowing through the electrodialysis membrane system 12 is in the range of about 9 to 12. In one embodiment, the CO₂ removal system 110 of FIG. 3 is used when the pH of the solution flowing through the electrodialysis membrane system 12 is in the range of about 9 to 14.

In addition, the carbon dioxide (CO₂) removal systems 10 and 110 employ one or more heat exchangers (not shown) for heat recovery purposes. For example, one or more heat exchangers (not shown) may be employed between the CO₂ absorber 20, 120 and the NH₃ regenerator 30, 130 for heat recovery between fluids exchanged between and flowing to and from the CO₂ absorber 20, 120 and the NH₃ regenerator 30, 130. Such heat exchangers reduce steam duty to the NH₃ regenerator 30, 130. One or more heat exchangers (not shown) may also be employed to remove heat generated in the CO₂ absorber 20, 120 as a result of an exothermic reaction of CO₂ absorption in the CO₂ absorber 20, 120. In addition, heat exchangers (not shown) may be employed to remove heat from the CO₂ water wash system 40, 140 and/or the NH3 water wash system 50, 150.

During operation of the CO₂ removal system 10 illustrated in FIG. 1, flue gas containing CO₂ is supplied to the absorber 20 via the inlet 22. For example, CO₂ rich flue gas, from a coal based power plant, containing about 8 to 15 vol % CO₂ can be supplied to the absorber 20; or CO₂ rich flue gas, from for a natural gas based power plant ,containing about 3 to 10 vol % CO₂ can be supplied to the absorber 20. An ionic solution including H₂O, NH₃ and NH4⁺ is supplied to the absorber 20 via the inlet 26. In one embodiment, the ionic solution supplied to the absorber 20 has an ammonia molarity of about 8 to 10 M. The ionic solution is sprayed into an interior area of the absorber 20 via a suitable liquid distribution device 81. The flue gas reacts with the ionic solution thereby removing a substantial amount of the CO₂ from the flue gas. The absorber 20 discharges CO₂ lean flue gas from the first outlet 24 to the inlet 55 of the NH₃ water wash system for recovery of the NH₃. For example, for the coal based power plant, CO₂ lean flue gas containing about 1 to 2 vol % CO₂ can be discharged from the first outlet 24. For a natural gas based power plant, flue gas containing about 0.1 to 1 vol % CO₂ can be discharged from the first outlet 24. NH₃ is recovered from the CO₂ lean flue gas as a result of a reaction with the water sprayed into the NH₃ water wash system. In one embodiment, the molarity of ammonia in the NH₃ water wash system 50 is about 1 to 1.5 M.

As a result of the reaction between the flue gas and the ionic solution, a feed solution, rich in CO₂ is collected at a lower portion 82 of the absorber 20. The feed solution includes about 0.57 molar % CO₂; 1.3 molar % NH₃; 80.6 molar % H₂O; 9.4 molar % NH⁴⁺; 4.4 molar % NH₂COO⁻; 3.7 molar % HCO³⁻; and 0.6 molar % CO₃²⁻. The feed solution is conveyed to the regenerator 30 via the first pump 33 and the lines 34. Heat is supplied to the regenerator via the hot leg 38 of the heat exchanger 35. The heat enables the CO₂ to be separated from the feed solution. As a result, a regenerated supply of ionic solution including H₂O, NH₃ and NH⁴⁺ is generated in the regenerator and subsequently recirculated to the absorber 20. In addition, a mixture of CO₂ and NH₃ is created in the regenerator 30 and discharged from the outlet 39 of the regenerator. The mixture of CO₂ and NH₃ is admitted to the CO₂ water wash system 40 via the first inlet 41. While the feed solution is described as including about 0.57 molar % CO₂; 1.3 molar % NH₃; 80.6 molar % H₂O; 9.4 molar % NH⁴⁺; 4.4 molar % NH₂COO⁻; 3.7 molar % HCO³⁻; and 0.6 molar % CO₃²⁻, the present disclosure is not limited in this regard as feed solutions having other chemical compositions can be employed. Although the a regenerated supply of ionic solution is described as including H₂O, NH₃ and NH⁴⁺ the present disclosure is not limited in this regard as ionic solutions having other compositions may also be employed without departing from the broader aspects disclosed herein.

Water is supplied to the CO₂ water wash system 40 by the electrodialysis membrane system 12 via the first outlet 14, the line 16 and the second inlet 42. The water is sprayed into an interior area defined by the CO₂ water wash system 40 through a liquid distribution system 83. Water is also sprayed into the interior area of the water wash system 40 through another liquid distribution system 84 via the third pump 44, the line 45 and the third inlet 46. The water spray absorbs the NH₃ in the mixture of CO₂ and NH₃, thereby separating the CO₂ from the mixture. The separated CO₂ is discharged from the water wash system 40 via line 49 for storage or further processing. In addition, the third pump 44 supplies a portion of an ionic solution collected in a lower portion 85 of the CO₂ water wash system 40 to a liquid distribution system 88 located in an interior area defined by the NH₃ water wash system 50, via the line 47 and the inlet 51. A portion the ionic solution collected at a lower portion 87 of the NH₃ water wash system is conveyed to the electrodialysis membrane system 12 via the fourth pump 53, the line 18 and the first inlet 17. The fourth pump 53 recirculates a portion of the ionic solution collected in a lower portion 85 to another liquid distribution system 89 located in the interior area defined by the NH₃ water wash system 50.

The ionic solution collected in a lower portion 85 of the NH₃ water wash system 50 and conveyed to the first inlet 17 and the cavity 62C of the electrodialysis membrane system 12 includes 96.6 molar % H₂O; and ionic species, such as, 2.2 molar % NH⁴⁺; 0.3 molar % NH₂COO⁻; 0.6 molar % HCO₃⁻; and 0.3 molar % CO₃²⁻. The cation exchange membrane 68 separates the NH⁴⁺ from the ionic solution and accumulates the NH⁴⁺ in the cavity 62D. The NH⁴⁺ is discharged from the electrodialysis membrane system 12 via the third outlet 19B. The anion exchange membrane 67 separates the NH₂COO⁻, the HCO₃⁻, and the CO₃²⁻ from the ionic solution and accumulates the NH₂COO⁻, the HCO₃⁻, and the CO₃²⁻ in the cavity 62B. The NH₂COO⁻, the HCO₃⁻, and the CO₃²⁻ are discharged from the electrodialysis membrane system 12 via the second outlet 19A. The NH⁴⁺ from the third outlet 19B mixes with the NH₂COO⁻, the HCO₃⁻, and the CO₃²⁻ from the second outlet 19A in the common line 19. The mixture of the ionic species NH⁴⁺, NH₂COO⁻, the HCO₃⁻, and the CO₃²⁻ is conveyed to the regenerator 30 via the fifth pump 60, the line 61 and the lines 34. A portion of the mixture of the ionic species NH⁴⁺, NH₂COO⁻, the HCO₃⁻, and the CO₃²⁻ is conveyed as a makeup to the NH₃ water wash system 50 via the branch line 91. As a result of the operation of the electrodialysis membrane system 12 and separation of the (NH⁴⁺) and the (NH₂COO⁻, the HCO₃⁻, and the CO₃²⁻) from the ionic solution, water is generated in the cavity 62C for use as a supply to the CO₂ water wash system 40.

While the NH₃ water wash system 50 is described as conveying 96.6 molar % H₂O; and ionic species, such as, 2.2 molar % NH⁴⁺; 0.3 molar % NH₂COO⁻; 0.6 molar % HCO₃⁻; and 0.3 molar % CO₃²⁻ to the cavity 62C of the electrodialysis membrane system 12, the present disclosure is not limited in this regard as other solutions and ionic species may also be generated in the NH₃ water wash system and/or processed in the electrodialysis membrane system 12.

The CO₂ removal system 110 of FIG. 3 is used when the pH of a solution flowing through the electrodialysis membrane system 112 is in the range of about 9 to 12. The CO₂ removal system 110 is operated similar to that described above for the CO₂ removal system 10 with the following exceptions. In the CO₂ removal system 110 H₂O is not conveyed to the CO₂ water wash system via line 16. Instead, a mixture of molecular H₂O and NH₃ is formed in the cavity 162C of the electrodialysis membrane system 112 of the CO₂ removal system 110. As illustrated in FIG. 3, the mixture of H₂O and molecular NH₃ is conveyed to the air stripper 170 via the second pump 115 and the line 116. Air is supplied to the air stripper 170 via the inlet 172 to assist in the removal of the molecular NH₃ from the mixture of molecular H₂O and NH₃. Air and the molecular NH₃ are discharged from the air stripper 170 via the first outlet 174 and are conveyed to the absorber 130 for further processing, via the line 177 ad the inlet 176. In addition, the sixth pump 180 conveys H₂O from the air stripper to the CO₂ water wash system 140.

Use of the electrodialysis membrane separator reduces the amount of energy required to operate the carbon dioxide removal system compared to prior art systems which use a steam consuming stripper column to separate the water and/or molecular ammonia from the ionic species in the ionic solution. For example, for coal fired power plants about a 20% reduction in energy requirements can be accomplished by using the electrodialysis membrane separator in lieu of the steam consuming stripper column For natural gas fired power plants, about a 15% reduction in energy requirements can be accomplished by using the electrodialysis membrane separator in lieu of the steam consuming stripper column For combined cycle power plants about a 40-50% reduction in energy requirements can be accomplished by using the electrodialysis membrane separator in lieu of the steam consuming stripper column. Thus the method for removing carbon dioxide from flue gas using the electrodialysis membrane separator is at least fifteen percent more efficient than carbon dioxide removal systems using steam consuming stripper columns, for natural gas fired power plants and at least twenty percent more efficient for coal fired power plants.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A carbon dioxide removal system comprising:
an absorber operable to receive flue gas and having an ionic solution in an interior area defined by the absorber, the ionic solution for removing carbon dioxide from the flue gas;
a regenerator in fluid communication with the absorber, the regenerator being operable to separate carbon dioxide from the ionic solution and to supply regenerated ionic solution to the absorber;
a carbon dioxide water wash system in communication with the regenerator, the carbon dioxide water wash system being operable to receive a mixture of carbon dioxide and ammonia from the regenerator and to separate the ammonia from the carbon dioxide;
an ammonia water wash system in communication with the absorber and the carbon dioxide water wash system, the ammonia water wash system being operable to remove ammonia from flue gas supplied thereto; and
a membrane separator in communication with at least one of the ammonia water wash system, the regenerator and the carbon dioxide water wash system.

2. The carbon dioxide removal system of claim 1, wherein the membrane separator is in communication with the ammonia water wash system and is operable to separate at least one of water and molecular ammonia from ionic species in the ionic solution.

3. The carbon dioxide removal system of claim 2, wherein the membrane separator is at least one of an electrodialysis membrane system, a nano filtration system and a reverse osmosis system.

4. The carbon dioxide removal system of claim 1, wherein the membrane separator is in communication with the carbon dioxide water wash system and is operable to supply water thereto.

5. The carbon dioxide removal system of claim 1, wherein the membrane separator is in communication with the regenerator and is operable to supply ionic species to the regenerator.

6. The carbon dioxide removal system of claim 5, wherein the ionic species comprise at least one of NH⁴⁺, NH₂COO⁻, HCO₃⁻, and CO₃²⁻.

7. The carbon dioxide removal system of claim 1, further comprising an air stripper in communication with the membrane separator, the membrane separator being operable to supply a mixture of water and molecular ammonia to the air stripper.

8. The carbon dioxide removal system of claim 7, wherein the air stripper is in communication with the carbon dioxide water wash system and is operable to supply water to the carbon dioxide water wash system.

9. The carbon dioxide removal system of claim 7, wherein the air stripper is in communication with the absorber and is operable to supply ammonia to the absorber.

10. The carbon dioxide removal system of claim 1, further comprising a second membrane separator having a retentate side and a permeate side separated by a membrane, the retentate side having an inlet in communication with the absorber and an outlet in communication with the regenerator, and the permeate side having another outlet in communication with the CO₂ water wash system.

11. The carbon dioxide removal system of claim 1, wherein the membrane separator comprises at least one cation exchange membrane and at least one anion exchange membrane positioned between a cathode and an anode.

12. A method for removing carbon dioxide from flue gas comprising:
providing an absorber having an ionic solution in an interior area defined by the absorber, a regenerator in fluid communication with the absorber, a carbon dioxide water wash system in communication with the regenerator, an ammonia water wash system in communication with the absorber and the carbon dioxide water wash system, and a membrane separator in communication with at least one of the ammonia water wash system, the regenerator and the carbon dioxide water wash system;
receiving carbon dioxide containing flue gas in the absorber;
supplying an ionic solution to the absorber;
removing at least a portion of the carbon dioxide from the flue gas using the ionic solution to create carbon dioxide lean flue gas;
conveying at least a portion of the ionic solution to the regenerator;
separating a mixture of the carbon dioxide and ammonia from the ionic solution in the regenerator;
conveying the mixture of the carbon dioxide and the ammonia to the carbon dioxide water wash system;
supplying water to the carbon dioxide water wash system;
in the carbon dioxide water wash system, separating carbon dioxide from the mixture of the carbon dioxide and the ammonia and creating a mixture of water and ammonia;
conveying the mixture of the water and the ammonia to the ammonia water wash system;
conveying carbon dioxide lean flue gas to the ammonia water wash system;
creating a mixture of ionic species and water in the ammonia water wash system;
conveying the mixture of ionic species and water to the membrane separator; and
separating, in the membrane separator, at least one of water and molecular ammonia from ionic species in the ionic solution.

13. The method of claim 12, comprising supplying water from the membrane separator to the carbon dioxide water wash system.

14. The method of claim 12, comprising supplying at least a portion of the ionic species to the regenerator.

15. The method of claim 12, comprising supplying at least a portion of the ionic species to the ammonia water wash system.

16. The method of claim 12, comprising providing an air stripper in communication with the membrane separator; and
supplying the water and the molecular ammonia to the air stripper.

17. The method of claim 16, comprising removing the ammonia from the water in the air stripper.

18. The method of claim 17, wherein the air stripper is in communication with the carbon dioxide water wash system and the water is supplied to the carbon dioxide system from the air stripper.

19. The method of claim 17, wherein the air stripper is in communication with the absorber and the ammonia is conveyed to the absorber from the air stripper.

20. The method of claim 12 wherein the method for removing carbon dioxide from flue gas is at least fifteen percent more efficient than carbon dioxide removal systems using steam consuming stripper columns.
